(19) United States
(12) Patent Application Publication
(10) Pub. No.: US 2013/0041714 A1
(43) Pub. Date: Feb. 14, 2013

(54) Supplier Risk Health Check

(71) Applicants: Matthew N. Henrich, Fort Mill, SC (US); Matthew Hinman, Huntersville, NC (US); Mark Killius, Charlotte, NC (US)

(72) Inventors: Matthew N. Henrich, Fort Mill, SC (US); Matthew Hinman, Huntersville, NC (US); Mark Killius, Charlotte, NC (US)

(73) Assignee: Bank of America Corporation, Charlotte, NC (US)

(21) Appl. No.: 13/209,027

(22) Filed: Aug. 12, 2011

(51) Int. Cl. G06Q 10/00

(52) U.S. Cl. 705/7.28

(57) ABSTRACT

A system and method for a supplier risk health check system is disclosed. A method for determining supplier risk includes receiving a first supplier data from a first data source, the first supplier data indicating a plurality of suppliers and one or more risk characteristics associated with each of the plurality of suppliers to an organization. The method further includes receiving a second supplier data from a second data source, the second supplier data indicating a plurality of suppliers and one or more risk characteristics associated with each of the plurality of suppliers to the organization. The method also includes for one or more of the suppliers indicated in the first supplier data, associating one or more risk characteristics indicated in the first supplier data with one or more risk characteristics indicated in the second supplier data.

### TECHNICAL FIELD OF THE INVENTION

The present disclosure relates to risk analysis systems generally, and more particularly to a supplier risk health check system.

### BACKGROUND OF THE INVENTION

Large organizations frequently have relationships with numerous suppliers, customers, and partners. These relationships often pose risks to large organizations in numerous ways, such as for example, operation, informational, and financial. Understanding these risks is challenging, since data regarding supplier relationships may be stored in numerous disparate data silos, with no comprehensive way of perceiving risks to the organization.

### SUMMARY OF THE INVENTION

In accordance with particular embodiments of the present disclosure, the disadvantages and problems associated with supplier risk health check systems have been substantially reduced or eliminated.

In accordance with a particular embodiment of the present disclosure, a method for determining a supplier health includes receiving a first supplier data from a first data source, the first supplier data indicating a plurality of suppliers and one or more risk characteristics associated with each of the plurality of suppliers to an organization. The method further includes receiving a second supplier data from a second data source, the second supplier data indicating a plurality of suppliers and one or more risk characteristics associated with each of the plurality of suppliers to the organization. The method also includes, for one or more of the suppliers indicated in the first supplier data, associating one or more risk characteristics indicated in the first supplier data with one or more risk characteristics indicated in the second supplier data. The method also includes selecting, based on user input, a supplier from the plurality of suppliers and based on the associated risk characteristics, calculating a supplier health score associated with the selected supplier.

In accordance with another embodiment of the present disclosure, a system for determining a supplier health includes a memory operable to store a first supplier data and a second supplier data. The system also includes a processor operable to receive a first supplier data from a first data source, the first supplier data indicating a plurality of suppliers and one or more risk characteristics associated with each of the plurality of suppliers to an organization. The processor is further operable to receive a second supplier data from a second data source, the second supplier data indicating a plurality of suppliers and one or more risk characteristics associated with each of the plurality of suppliers to the organization. The processor is also operable to, for one or more of the suppliers indicated in the first supplier data, associate one or more risk characteristics indicated in the first supplier data with one or more risk characteristics indicated in the second supplier data. The processor is also operable to select, based on user input, a supplier from the plurality of suppliers and based on the associated risk characteristics, calculate a supplier health score associated with the selected supplier.

In accordance with yet another embodiment of the present disclosure, a non-transitory computer-readable medium includes logic, and the logic is operable, when executed on a processor, to receive a first supplier data from a first data source, the first supplier data indicating a plurality of suppliers and one or more risk characteristics associated with each of the plurality of suppliers to an organization. The logic is further operable to receive a second supplier data from a second data source, the second supplier data indicating a plurality of suppliers and one or more risk characteristics associated with each of the plurality of suppliers to the organization. The logic is also operable to, for one or more of the suppliers indicated in the first supplier data, associate one or more risk characteristics indicated in the first supplier data with one or more risk characteristics indicated in the second supplier data. The logic is also operable to select, based on user input, a supplier from the plurality of suppliers. Additionally, the logic is operable to, based on the associated risk characteristics, calculate a supplier health score associated with the selected supplier.

Technical advantages provided by particular embodiments of the present disclosure may include presenting a portfolio level dashboard view of suppliers and summarizing key supplier data. Some embodiments may provide for added drill-down supplier summary detail on a single supplier via a one page view. Moreover, dashboard key metrics are calculated based on filtering of any number of filters. Additionally, in some embodiments, particular embodiments provide quick and reliable access to supplier risk information for decision making. For example, particular embodiments of the present disclosure may enable a user to make decisions on supplier spending, risk management, contract variance and expiration, service levels, and/or any other relevant information associated with suppliers. Moreover, particular embodiments may provide a deeper understanding of supplier risks to an organization than has been previously available. Additionally, particular embodiments provide a full understanding of the supplier relationship not only as a service provider to an organization, but also as a client and customer. As a result, embodiments of the disclosure may provide numerous technical advantages. Particular embodiments may provide some, none, all, or additional technical advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates a supplier risk analysis system according to particular embodiments of the present disclosure;

FIG. 2 illustrates an example Graphical User Interface provided by particular embodiments of the risk analysis system of FIG. 1;

FIG. 3 illustrates an example Graphical User Interface provided by particular embodiments of the risk analysis system of FIG. 1;

FIG. 4 is a flow diagram illustrating a particular operation of the system of FIG. 1 in accordance with particular embodiments of the present disclosure; and

FIG. 5 is a flow diagram illustrating a particular operation of the risk analysis system of FIG. 1 in accordance with particular embodiments of the present disclosure.

### DETAILED DESCRIPTION OF THE INVENTION

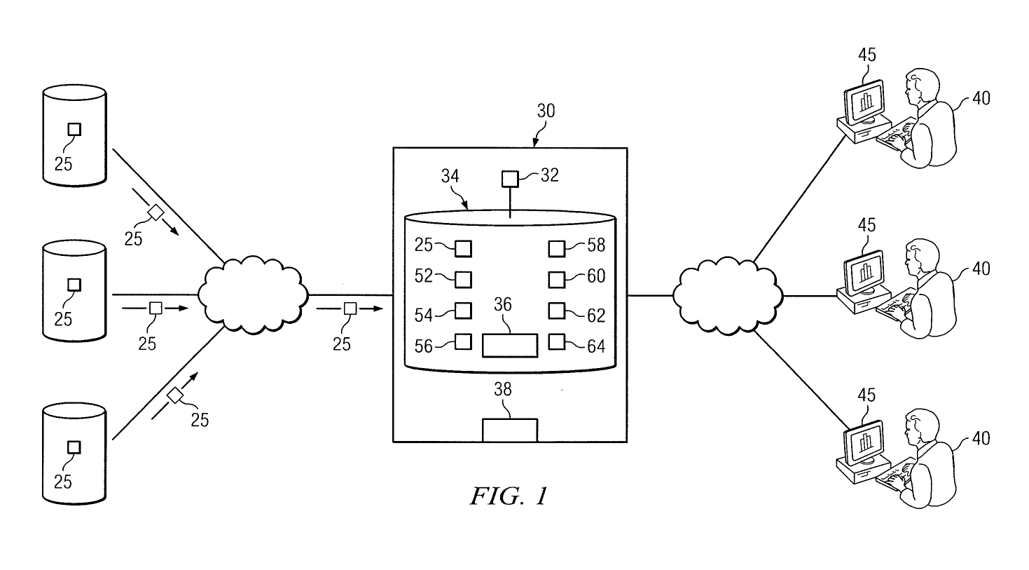

A system and method for a supplier health check is disclosed. FIG. 1 illustrates a particular embodiment of the present disclosure that includes supplier risk analysis system 10, data sources 20, risk analysis server 30, users 40, and network 50. In general, supplier risk analysis system 10 provides information to users 40 about suppliers to an organization. In particular embodiments, supplier risk analysis system 10 provides information on the risk a supplier presents to an organization. A supplier may represent any company, individual, firm, business, enterprise, and/or other organization, that provides any good or service to an organization. For example, a supplier may represent a software vendor that provides accounting software to an organization, a law firm that provides legal services to an organization, and/or a postal firm that provides mailing services to an organization. In particular embodiments, an organization may collect and/or store various characteristics associated with each supplier. For example, an organization may store information associated with (i) an amount the organization spends with the supplier each year; (ii) a contract term associated with the supplier; (iii) a statement of work associated with the supplier; (iv) a criticality of the service provided by the supplier; (v) financial contract terms associated with the supplier (e.g., whether a contract is written on organization paper or supplier paper); (vi) one or more products provided by the supplier; (vii) contract provisions associated with the supplier; (viii) a contact representative associated with the supplier; (ix) information security provided by the supplier; (x) a continuity assessment associated with the supplier; (xi) performance metrics associated with the supplier; and/or (xii) any other information relevant to a supplier or a supplier's relationship to an organization. In general, an organization may collect and/or store these or any other types of information associated with one or more suppliers to the organization.

In some embodiments, one or more suppliers to an organization may be associated with a risk to the organization. Risk may include risk that a contract is not renewed, a product is no longer able to be provided, a supplier no longer stays in business, customer information associated with the organization is not secure, a supplier is exposed to threat of litigation or regulatory penalties, and/or any other risk to the organization associated with the supplier.

Supplier risk analysis system 10 may receive data associated with a supplier and calculate one or more risk assessment metrics indicating one or more risks to an organization. In particular embodiments, supplier risk analysis system 10 receives data associated with a supplier from disparate data sources. Different data sources may provide data to other components of supplier risk analysis system 10 in different formats. Supplier risk analysis system 10 may aggregate, coalesce, collate, organize, and/or collect information from disparate data sources and calculate one or more risks to an organization associated with one or more suppliers. As a result, supplier risk analysis system 10 may present a holistic view of supplier risk to an organization.

Thus, in accordance with particular embodiments of the present disclosure, various components of supplier risk analysis system 10 that collectively and/or independently perform these and/or additional operations are now described with respect to FIG. 1.

Data sources 20a, 20b, 20c, and 20d (which may be individually referred to as data source 20 or collectively as data sources 20) represent data storage devices and/or information services that store, generate, and/or transmit supplier data 25 to other components of supplier risk analysis system 10. Data sources 20 represent any device and/or service capable of storing, retrieving, generating, transmitting and/or processing any suitable form of electronic data. In some embodiments, data source 20 may comprise a general-purpose personal computer (PC), a Macintosh, a workstation, a Unix-based computer, a server computer, or any suitable processing device. In general, however, data source 20 may include any appropriate combination of hardware, software, and/or encoded logic suitable to perform the described functionality. Moreover, the functions and operations described above may be performed by a pool of data sources 20.

Supplier data 25 represents information associated with a supplier. For example, supplier data 25 may include performance data associated with a supplier. Performance data may include a supplier name, unique identification number, and a metric indicating and/or associated with a supplier's performance under a contract between the supplier and an organization. Supplier data 25 may additionally or alternatively include contract data. Contract data may include a supplier name, an identification number of a supplier, a contract termination date, one or more contract provisions or terms, a contract price, one or more statements of work, and/or any other information associated with a contract between a supplier and an organization. Supplier data 25 may additionally or alternatively include financial data associated with a supplier. Financial data may include any financial information associated with a supplier, such as, for example, an amount of revenue generated by a supplier, profitability of a supplier, and/or market share of a supplier. Supplier data 25 may additionally or alternatively include supplier assessment data. For example, an organization may gather data to determine information security controls associated with a supplier. Information security controls may represent the degree of security a supplier has over customer, financial, or other sensitive data. An organization may also determine business continuity data. Business continuity data may represent the likelihood a supplier will continue operations in the future, thus being available to provide continued goods or services to an organization. In general, supplier data 25 may indicate any information relevant to a relationship between a supplier and an organization.

Risk analysis server 30 receives supplier data 25 from one or more data sources 20. Risk analysis server 30 process supplier data 25 to generate one or more risk assessment metrics associated with one or more suppliers, and may generate a risk assessment metric associated with a group of suppliers. Risk analysis server 30 may display one or more graphical user interfaces that include one or more risk assessment metrics to users 40. Additionally or alternatively, risk analysis server 30 may selectively display data requested by one or more users 40. For example, risk analysis server 30 may receive user input requesting supplier data for all suppliers that meet the criteria of being a supplier that (i) is categorized as a Tier 1 supplier; (ii) receives more than $20 million dollars in spending per year; and (iii) has a contract that will expire in 18 months. Risk analysis server 30 may then selectively display information associated with supplier that meet the requested criteria.

In particular embodiments, risk analysis server 30 represents a mainframe computer system that receives and/or processes supplier data 25 associated with one or more suppliers from data sources 20. In some embodiments, risk analysis server 30 may comprise a general-purpose personal computer (PC), a Macintosh, a workstation, a Unix-based computer, a server computer, or any suitable processing device. In general, however, risk analysis server 30 may include any appropriate combination of hardware, software, and/or encoded logic suitable to perform the described functionality. Moreover, the functions and operations described above may be performed by a pool of risk analysis servers 30.

In particular embodiments, risk analysis server 30 includes processor 32, memory 34, logic 36, and network interface 38. Memory 34 comprises any suitable arrangement of random access memory (RAM), read only memory (ROM), magnetic computer disk, CD-ROM, repository, other magnetic or optical storage media, or any other volatile or non-volatile memory device that stores one or more files, lists, tables, or other arrangements of information, such as risk assessment metrics, information security risk score 52, business continuity risk score 54, operational risk score 56, supply chain risk score 58, financial risk score 60, supplier health score 62, and/or overall supplier relationship score 64. Although FIG. 1 illustrates memory 34 as internal to risk analysis server 30, it should be understood that memory 34 may be internal or external to risk analysis server 30, depending on particular implementations. Memory 34 may be separate from or integral to other memory devices to achieve any suitable arrangement of memory devices for use in supplier risk analysis system 10.

Memory 34 is further operable to store logic 36. Logic 36 generally comprises rules, algorithms, code, tables, and/or other suitable instructions for performing operations described herein. Memory 34 is communicatively coupled to processor 32. Processor 32 is generally operable to execute logic to perform operations described herein. Processor 32 comprises any suitable combination of hardware and software implemented in one or more modules to provide the described function or operation.

Network interface 38 communicates information with one or more networks 50. For example, network interface 38 may communicate with data sources 20 over network 50 through network interface 38. A network may include communication using internet protocol packets, frame relay frames, asynchronous transfer mode cells, and/or other suitable information between network addresses. A network may include one or more intranets, local area networks, metropolitan area networks, wide area networks, cellular networks, all or a portion of the Internet, and/or any other communication system or systems at one or more locations.

Users 40 (who may be individually referred to as “user 40” or collectively as “users 40”) represent users within or members of an organization. Users 40 may represent employees, partners, managers, and/or any person within an organization. A particular user 40 may communicate with risk analysis server 30 to view one or more risk assessment metrics, information security risk score 52, business continuity risk score 54, operational risk score 56, supply chain risk score 58, and/or financial risk score 60 associated with one or more suppliers. Users 40 may communicate with risk analysis server 30 over network 50 utilizing risk analysis workstation 45.

Risk analysis workstation 45 represents any computer workstation, server, and/or other computer suitable to perform the described operations. For example, in some embodiments, risk analysis workstation 45 may comprise a general-purpose personal computer (PC), a Macintosh, a workstation, a Unix-based computer, a server computer, or any suitable processing device. In general, however, risk analysis workstation 45 may represent any appropriate combination of hardware, software, and/or encoded logic suitable to perform the described functionality. Moreover, the functions and operations described above may be performed by a pool of risk analysis workstations 45.

Network 50 represents any number and combination of wireline and/or wireless packet-switched or circuit-switched networks suitable for data transmission. Data sources 20 and/or risk analysis server 30 are communicatively coupled via one or more networks 50. In particular embodiments, users 40 may communicate with risk analysis server 30 via one or more computers, telephones, cell phones, or other communication devices coupled to network 50. In particular embodiments, risk analysis server 30 may communicatively couple to data sources 20 via network 50. Network 50 may, for example, communicate internet protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations.

Modification, additions, or omissions may be made to supplier risk analysis system 10 without departing form the scope of the present disclosure. For example, when a component of supplier risk analysis system 10 determines information, the component may determine the information locally or may receive the information from a remote location. In the illustrated embodiment, risk analysis server 30 and data sources 20 are represented as different components of supplier risk analysis system 10. The functions of risk analysis server 30 and data sources 20, however, may be performed by any suitable combination of one or more servers or other components at one or more locations. Additionally, risk analysis server 30 and data sources 20 may represent the same component within supplier risk analysis system 10. In the embodiment where the various components are servers, the servers may be public or private servers, and each server may be a virtual or physical server. The server may include one or more servers at the same or at remote locations. Also, risk analysis server 30 and data sources 20 may include any suitable component that functions as a server. Additionally, supplier risk analysis system 10 may include any appropriate number of risk analysis servers 30 and data sources 20. Any suitable logic may perform the functions of supplier risk analysis system 10 and the components within supplier risk analysis system 10.

Supplier Risk Dashboard

An example operation of supplier risk analysis system 10 in accordance with particular embodiments of the present disclosure is now described. In particular embodiments, data sources 20a-d collect and/or store supplier data 25. As discussed above, supplier data 25 may represent (i) an amount the organization spends with the supplier each year; (ii) a contract term associated with the supplier; (iii) a statement of work associated with the supplier; (iv) a criticality of the service provided by the supplier; (v) financial contract terms associated with the supplier (e.g., whether a contract is written on organization paper or supplier paper); (vi) one or more products provided by the supplier; (vii) contract provisions associated with the supplier; (viii) a contact representative associated with the supplier; (ix) information security provided by the supplier; (x) a continuity assessment associated with the supplier; (xi) performance metrics associated with the supplier; and/or (xii) any other information relevant to a supplier or a supplier's relationship to an organization. An organization may collect and/or store supplier data 25 by conducting surveys of suppliers, reviewing public records, aggregating previously stored data (such as, e.g. name, address, or region of a supplier), and/or in any other appropriate manner.

In particular embodiments, once data sources 20 collect and/or store supplier data 25, one or more data sources 20 transmit supplier data 25 to risk analysis server 30. Data sources 20 may transmit supplier data 25 to risk analysis server 30 periodically and/or in response to a request from risk analysis server 30 and/or users 40 utilizing workstations 45.

Risk analysis server 30 receives supplier data 25 from one or more data sources 20. In some embodiments, a particular supplier data 25 may be in different format and/or condition relative to other supplier data 25 associated with the same supplier. For example, some supplier data 25 may include data fields that other supplier data 25 does not include, or contains fields in a different order, or includes fields of a different data type. Risk analysis server 30 may reformat, condition, and/or otherwise analyze supplier data 25 in any appropriate manner to collate and/or associate supplier data 25 received from disparate data sources 20. For example, risk analysis server 30 may determine that a supplier identification number in a first supplier data 25 received from data source 20a is the same as a supplier identification number in a second supplier data 25 received from data source 20b. Risk analysis server 30 may then determine that the first supplier data 25 and the second supplier data 25 are associated with the same supplier, and should analyze the risk associated with the supplier utilizing all or part of both the first supplier data 25 and the second supplier data 25.

Based on received supplier data 25, risk analysis server 30 may calculate one or more risk assessment metrics. For example, risk analysis server 30 may calculate a deliverable quality index. A deliverable quality index may represent a degree of compliance with regulatory and/or other requirements associated with one or more suppliers. For example, a supplier may be required to possess insurance and/or file financial statements with a regulatory body. Based on supplier data 25, risk analysis server 30 may determine whether a supplier complies with regulatory or other requirements. A deliverable quality index may be calculated or otherwise determined based on an aggregate metric of one or more suppliers, and in particular embodiments, may be measured in percentage terms. For example, each suppliers' compliance may be measured as a percent (e.g., 75% compliant), and multiple suppliers may be weighted-averaged to calculate a deliverable quality index.

In some embodiments, risk analysis server 30 additionally or alternatively calculates a performance scorecard. A performance scorecard may represent the level at which one or more suppliers are performing under the terms and conditions of a contract or other performance agreement between one or more suppliers and an organization. For example, a postal supplier may be required to send 95% of mailings on time every month. If the postal supplier meets this performance requirement, risk analysis server 30 may determine that a performance scorecard metric associated with the postal supplier is 100%. If the postal supplier does not send 95% of mailings on time every month, postal supplier may determine that a performance scorecard metric associated with the postal supplier is less than 100% (depending, in part, on the actual degree of underperformance.) A performance scorecard may be calculated or otherwise determined based on an aggregate of one or more supplier's performance, and in particular embodiments, may be measured in percentage terms. For example, each suppliers' performance may be measured as a percentage (e.g., 75% performance), and multiple suppliers may be weighted-averaged to calculate an overall performance scorecard.

In some embodiments, risk analysis server 30 additionally or alternatively calculates a supplier risk index. A supplier risk index may represent a level of information security controls and/or business continuity controls associated with a supplier. For example, an organization may determine whether a supplier has access to customer data of the organization. The organization may further determine how much customer data the supplier has access to and/or how often the customer data is accessed. Based on this information, risk analysis server 30 may additionally determine whether information security controls are adequate. An organization may also determine the likelihood of a supplier's business continuity (such as, for example, how likely a business is to remain operational in order to supply an organization with goods or services). In certain embodiments, survey data provided by suppliers may be utilized in whole or in part to a level of information security controls and/or business continuity controls. A supplier risk index may be calculated or otherwise determined based on an aggregate metric information security controls and/or business continuity controls associated with suppliers, and in particular embodiments, may be measured in percentage terms. For example, each suppliers' performance may be measured as a percent (e.g., 75% secure), and multiple suppliers may be weighted-averaged to calculate an overall supplier risk index.

Once one or more supplier risk assessment metrics are calculated, risk analysis server 30 may calculate a supplier portfolio index. A supplier portfolio index may be an average of a deliverable quality index, a performance scorecard, and a supplier risk index. This may be represented as a percentage (such as, e.g., 86% secure). A supplier portfolio index may provide a holistic view of the risk associated with one or more, or all of the suppliers to an organization.

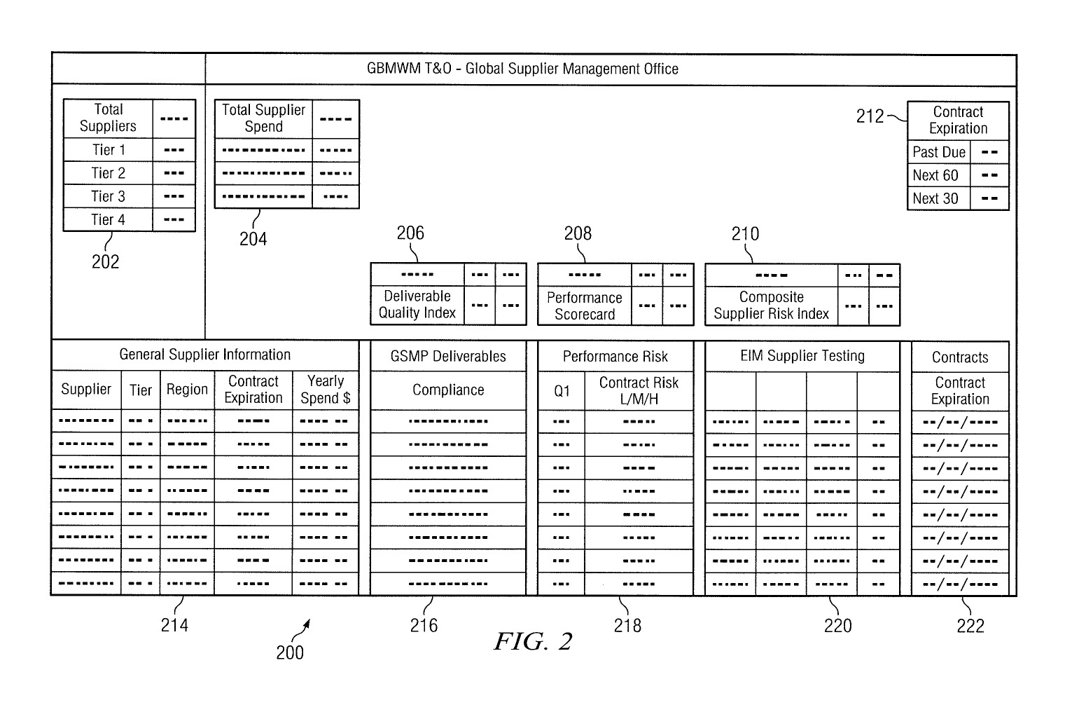

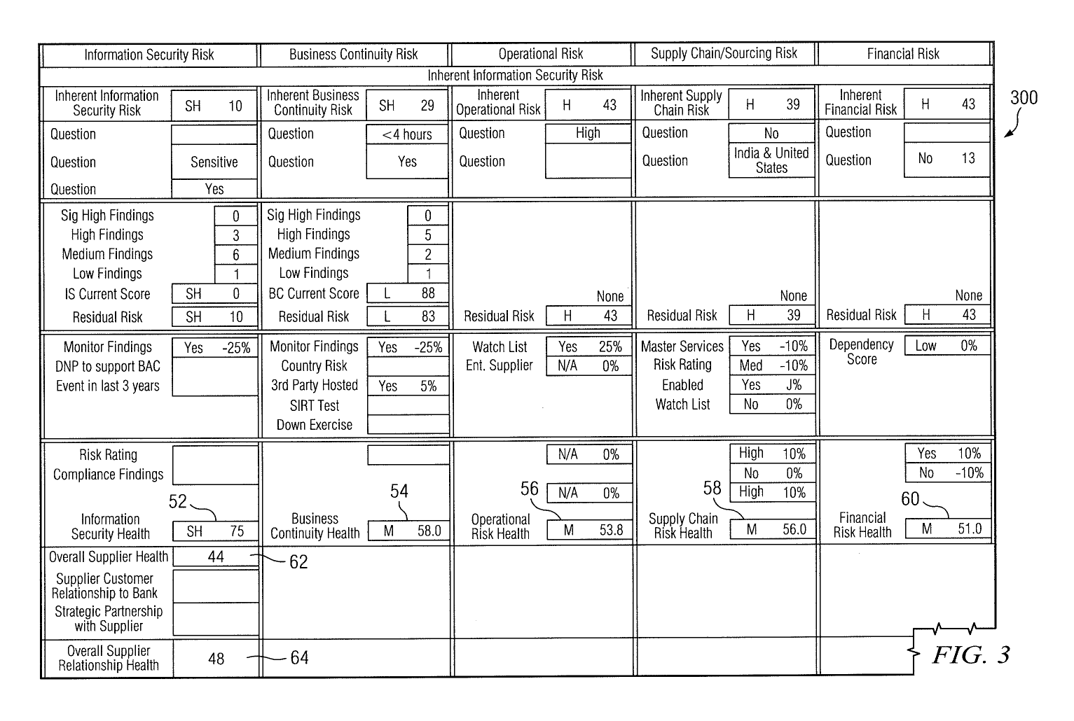

Users 40 at workstations 45 may connect to risk analysis server 30 to view risk assessment metrics and/or supplier data 25 associated with one or more suppliers. For example, in certain embodiments, users 40 may view a Graphical User Interface (GUI), as described further below with respect to FIGS. 2 and 3. In particular embodiments, a GUI displays one or more suppliers of an organization. Suppliers may be selectable based on user-defined criteria. As one example, user 40 may request to view risk information associated with suppliers that are (i) categorized as Tier 1 or 2 suppliers; (ii) receive more than $10 million dollars in spending per year; and (iii) have a contract that will expire in 12 months. This may enable user 40 to determine which contracts at a particular level of importance or value are expiring, and the relative risks associated with those suppliers. Thus, supplier risk analysis system 10 provides information on supplier risk to user 40.

Supplier Health Check

In some embodiments, risk analysis server 30 calculates, for one or more suppliers, a supplier health score 62 and overall supplier relationship score 64 based in part on supplier data 25 received from data sources 20. Supplier health score 62 and overall supplier relationship score 64 are numerical representations of an overall quality and stability of a supplier's relationship to an organization. Moreover, in some embodiments, a supplier may represent a supplier, strategic partner, and/or a client of an organization. Supplier health score 62 and overall supplier relationship score 64 may be calculated on a scale from one to one hundred with one representing a high-risk supplier, and one hundred representing a low-risk supplier. Supplier health score 62 and overall supplier relationship health score 64 may be based, at least in part, on information security risk score 52, business continuity risk score 54, operational risk score 56, supply chain risk score 58, and/or financial risk score 60 calculated by risk analysis server 30.

Risk analysis server 30 calculates information security risk score 52, business continuity risk score 54, operational risk score 56, supply chain risk score 58, and/or financial risk score 60 from supplier data 25. Information security risk score 52 may be calculated based on an inherent information security risk value and additional supplier data 25. An inherent information security risk value may be determined based on survey data completed by a supplier and transmitted as supplier data 25 to risk analysis server 30. An inherent information security risk value may represent a degree of security a supplier has over customer, financial, or other sensitive data. Additional information, such as, for example, whether a supplier is working with an organization to improve its information security, whether there has been a privacy breach with information within a predetermined time period, whether a supplier uses outdated technology, whether a supplier has undergone a security audit, the results of any information security audits, and/or compliance with third-party security guidelines may each be assigned a value and combined with an inherent information security risk value. For example, risk analysis server 30 assigns an inherent information security inherent value a value of 10. Risk analysis server 30 may further calculate the additional information described above to have a value of −25%. Risk analysis server may add −25% to 10 and determine that information security risk score 52 is 7.5.

Risk analysis server 30 calculates business continuity risk score 54 based in part on an inherent business continuity risk value. An inherent business continuity risk value may be based on supplier data 25 received from data sources 20. An inherent business continuity risk value represents likelihood a supplier will continue operations, thus being available to provide continued goods or services to an organization. An inherent business continuity risk value may be determined based on survey data completed by a supplier and transmitted as supplier data 25 to risk analysis server 30. Additional information, such as, for example, whether a supplier is working with an organization to remedy deficiencies in business continuity, whether the supplier is operating in a country with a high degree of crime, terrorism, and/or political risk, whether an application is hosted by the supplier or the organization, and/or whether a test exercise of business continuity has been conducted may each be assigned a value and combined with an inherent business continuity value to calculate business continuity risk score 54, in a manner similar to calculating information security risk score 52.

Risk analysis server 30 calculates operational risk score 56 based on an inherent operational risk value and additional supplier data 25. An inherent operational risk value may be based on supplier data 25, and represents the risk to operations of an organization if supplier is no longer available, including reputational risk. An inherent operational risk value may be determined based at least in part on supplier data 25. Additional information, such as, for example, whether a supplier is meeting service level agreements, whether application recovery times are satisfactory, whether audits of change management have been performed, and/or the results of audits of change management may each be assigned a value and combined with an inherent operational risk value to calculate operational risk score 56, in a manner similar to calculating information security risk score 52.

Risk analysis server 30 calculates supply chain risk score 58 based on an inherent supply chain risk value and additional supplier data 25. An inherent supply chain risk value may be based on supplier data 25, and represents the risk to the supply chain of a supplier and/or organization. Additional information, such as, for example, whether a supplier has an evergreen contract, has received demand letters within a predetermined time period, whether a contract covers deliverable quality requirements, whether the supplier is compliant with deliverable quality requirements, whether deliverable quality waivers exist may each be assigned a value and combined with an inherent business continuity value to calculate supply chain risk score 58, in a manner similar to calculating information security risk score 52.

Risk analysis server 30 calculates financial risk score 60 based on an financial risk value and additional supplier data 25. An inherent financial risk value may be based on supplier data 25, and represents the financial risk to an organization by a supplier. Additional information, such as, for example, whether revenue from a supplier is dependable, whether a line of business contingency plan is completed, whether a line of business contingency plan meets service level agreements, and/or whether the latest source code from an application vendor is in escrow may each be assigned a value and combined with an inherent business continuity value to calculate financial risk score 60, in a manner similar to calculating information security risk score 52.

Once risk analysis server 30 calculates information security risk score 52, business continuity risk score 54, operational risk score 56, supply chain risk score 58, and/or financial risk score 60, risk analysis server 30 calculates supplier health score 62. Supplier health score 62 may be based on a weighted average of information security risk score 52, business continuity risk score 54, operational risk score 56, supply chain risk score 58, and/or financial risk score 60. For example, information security risk score 52 may be calculated to be 7.5, business continuity risk score 54 may be calculated to be 58, operational risk score 56 may be calculated to be 53, supply chain risk score 58 may be calculated to be 56, and financial risk score 51 may be calculated to be 51. Predetermined weights may be applied to each respective score. As an example, a weight applied to information security risk score 52 may be 30%, business continuity risk score 54 may be 30%, operational risk score 56 may be 16%, supply chain risk score 58 may be 12%, and financial risk score 60 may be 12%. However, in general, any appropriate percentages may be applied depending on the particular configuration of supplier risk analysis system 10. Risk analysis server 30 applies those percentage to their respective scores to determine supplier health score 62, which, for purposes of this example, has a value of 44.

In some embodiments, risk analysis server 30 may add a percentage to supplier health score 62 if a supplier has a customer relationship with an organization and/or has a partnership relationship to the organization to determine overall supplier relationship score 64. For example, risk analysis server 30 determines that a supplier has a customer relationship with the organization, and adds 10% to supplier health score 62. Thus, overall relationship health score 64 is 48 for purposes of this example.

By collating disparate measurements of supplier risk and presenting a holistic view of risks to an organization posed by suppliers, supplier risk analysis system 10 provides numerous operational benefits. For example, supplier risk analysis system 10 may present a portfolio level dashboard view of suppliers and summarizes key supplier data. Some embodiments may provide for added drill-down supplier summary detail on a single supplier via a one page view. Moreover, dashboard key metrics are calculated based on filtering of any number of filters. Additionally, in some embodiments, risk analysis system 10 provides quick and reliable access to supplier risk information for decision making. For example, supplier risk analysis system 10 may enable a user to make decisions on supplier spending, risk management, contract continuation, service levels, and/or any other relevant information associated with suppliers. Moreover, particular embodiments may provide a deeper understanding of supplier risks to an organization than has been previously available. Additionally, particular embodiments provide a full understanding of the supplier relationship not only as a service provider to an organization, but also as a client and customer. As a result, supplier risk analysis system 10 may provide numerous operational benefits. Particular embodiments of supplier risk analysis system 10 may provide some, none, all, or additional operational benefits.

FIG. 2 illustrates an example graphical user interface (GUI) 200 that may be utilized in particular embodiments of supplier risk analysis system 10. For example, a user may utilize GUI 200 to view risk assessment metrics and/or supplier data 25 calculated by risk analysis server 30. In some embodiments, GUI 200 is displayed on risk analysis workstation 45 when user 40 logs in to and/or otherwise communicatively couples to risk analysis server 30. GUI 200 may include total suppliers box 202, total spend box 204, deliverable quality index box 206, performance scorecard box 208, supplier risk index box 210, contract expiration summary box 212, supplier information box 214, deliverables box 216, performance risk box 218, supplier testing box 220, and contract expiration box 222.

In general, total suppliers box 202, total spend box 204, deliverable quality index box 206, performance scorecard box 208, supplier risk index box 210, and contract expiration summary box 212 provide user 40 with an overview of various aspects of supplier risk associated with suppliers of an organization. In particular, total suppliers box 202 may display the total number of suppliers of an organization. In particular embodiments, the total number of suppliers of an organization may be categorized into tiers. A tier may represent a total amount received by an supplier from the organization or any other indication of a supplier's relative importance to an organization. In particular embodiments, total suppliers box 202 may display the total number of suppliers in each respective tier.

Total spend box 204 displays the total amount of dollars an organization spends on suppliers over a predetermined time period. For example, total spend box 204 may display a total amount spent in the previous fiscal year. Additionally or alternatively, total spend box 204 may display an amount of spending on suppliers to an organization per quarter, in a half-year period, or any other appropriate time period.

Deliverable quality index box 206 displays the percentage compliance with regulatory or other requirements of suppliers. As discussed above with respect to FIG. 1, risk analysis server 30 may calculate a deliverable quality index for one or more suppliers. Deliverable quality index box 206 displays to user 40 the average compliance for one or more selected suppliers.

Performance scorecard box 208 displays the level at which one or more suppliers are performing under the terms and conditions of contracts or other performance agreements between one or more suppliers and an organization. As discussed above with respect to FIG. 1, risk analysis sever 30 may calculate a performance scorecard that measures a supplier's performance under a contract or other agreement. Performance scorecard box 208 displays the average performance scorecard for one or more selected suppliers.

Supplier risk index box 210 displays a level of information security controls and/or business continuity controls associated with one or more suppliers. As discussed above with respect to FIG. 1, risk analysis server 30 may calculate a supplier risk index based on information security controls and/or business continuity controls associated with a supplier. Supplier risk index box 210 may display a percentage that represents the supplier risk index for one or more selected suppliers. In some embodiments, supplier risk index box 210 displays an average of the values displayed in supplier testing box 218.

Contract expiration summary box 212 displays a number of contracts expiring within a selected time frame. For example, user 40 may request that risk analysis server 30 display all contracts expiring within 12, 18 and 24 months, and/or contracts that have already expired. The total number of contracts meeting the requested criteria may be displayed in contract expiration summary box 212.

Supplier information box 214 displays information associated with each supplier of an organization. Supplier information box 214 may include a line item for each supplier. In particular embodiments, supplier information may include a name of the supplier, which tier a supplier is categorized in, part of an organization the supplier is associated with, which geographical region the supplier is associated with, a manager and/or contact person within an organization associated with the supplier, an amount spent by the organization on the supplier, and/or any other appropriate information associated with a supplier. In some embodiments, supplier information box 214 may be sortable based on any appropriate field included in supplier information box 214. Moreover, each row in deliverables box 216, performance risk box 218, supplier testing box 220, and contract expiration box 222 may be associated with the same row in supplier information box 214. Thus, sorting supplier information box 214 may also sort deliverables box 216, performance risk box 218, supplier testing box 220, and contract expiration box 222.

Deliverables box 216 displays compliance with regulator and/or other requirements for one or more selected suppliers. As discussed above with respect to FIG. 1, risk analysis server 30 calculates a deliverable quality index for each supplier, based on each suppliers' compliance with regulatory and/or other requirements. Deliverables box 216 displays the calculation obtained for one or more selected suppliers. In some embodiments, deliverables box 216 displays a deliverable quality index as a percentage, representing the degree of compliance with regulatory and/or other requirements.

Performance risk box 218 displays, for each supplier, a level at which a respective supplier is performing under the terms and conditions of a contract or other performance agreement between a supplier and an organization. As discussed above with respect to FIG. 1, risk analysis server 30 calculates a performance risk for each supplier, based on each suppliers' performance under a contract. Performance risk box 216 displays, for each supplier, the calculation obtained for one or more selected suppliers. In some embodiments, performance risk box 216 displays a performance risk as a percentage, representing the degree of performance associated with a supplier.

Supplier testing box 220 displays a level of information security controls and/or business continuity controls associated with a supplier. As discussed above with respect to FIG. 1, risk analysis server 30 may calculate a supplier risk index based on information security controls and/or business continuity controls associated with a supplier. Supplier risk index box 210 may display a percentage that represents the supplier risk index for one or more selected suppliers.

Contract expiration box 222 displays a contract expiration date for one or more selected suppliers. For each supplier listed in supplier information box 214, risk analysis server 30 may calculate a contract expiration associated with the respective supplier. Risk analysis server 30 may display the calculated contract expiration date in contract expiration box 222.

FIG. 3 illustrates an example graphical user interface (GUI) 300 that may be utilized in particular embodiments of supplier risk analysis system 10. For example, a user may utilize GUI 300 to calculate and/or view supplier health score 62 and/or overall relationship health score 64. For example, as shown in FIG. 3, GUI 300 may display information security risk score 52, business continuity risk score 54, operational risk score 56, supply chain risk score 58, and/or financial risk score 60, supplier health score 62, overall supplier relationship health score 64 and associated supplier data 25. As shown in FIG. 3, information security risk score 52, business continuity risk score 54, operational risk score 56, supply chain risk score 58, and/or financial risk score 60, may be weighted-averaged to calculate supplier health score 62. Then, as discussed above with respect to FIG. 1, risk analysis server may calculate overall supplier relationship health score 64 by adding an additional percentage to supplier health score 62 if a supplier is in a customer and/or strategic partnership relationship with an organization.

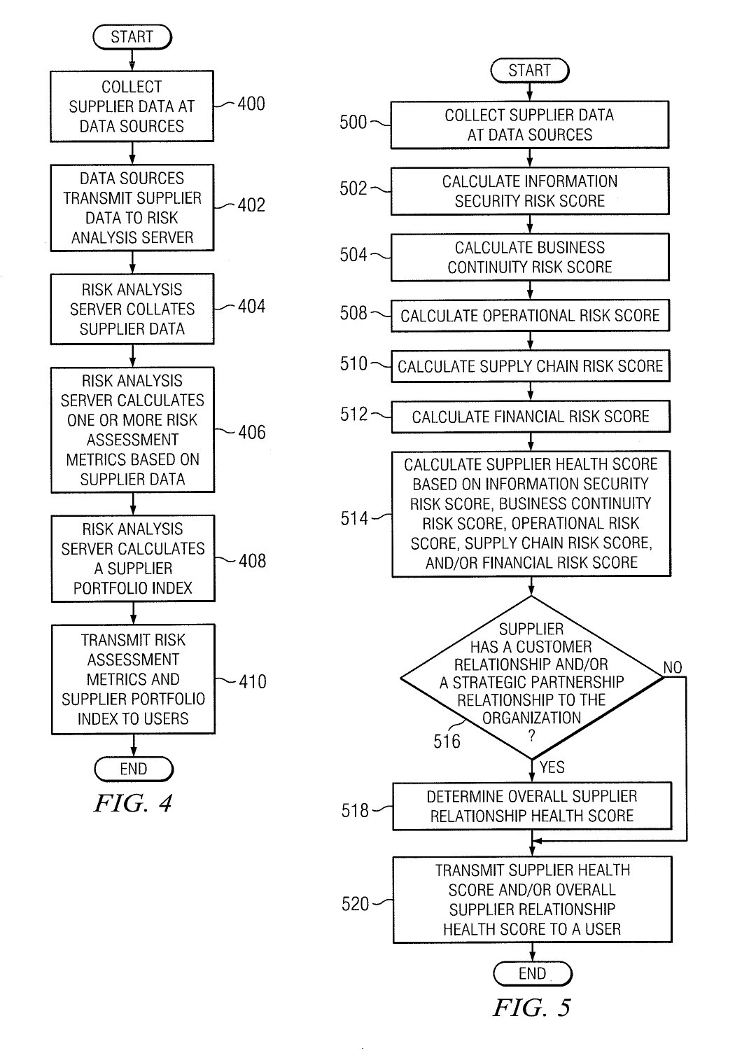

FIG. 4 is a flow diagram illustrating an operation in accordance with a particular embodiment of supplier risk analysis system 10. In the illustrated example, operation begins at step 400 with data sources 20a-d collecting and/or storing supplier data 25. As discussed above, supplier data 25 may represent (i) an amount the organization spends with the supplier each year; (ii) a contract term associated with the supplier; (iii) a statement of work associated with the supplier; (iv) a criticality of the service provided by the supplier; (v) financial contract terms associated with the supplier (e.g., whether a contract is written on organization paper or supplier paper); (vi) one or more products provided by the supplier; (vii) contract provisions associated with the supplier; (viii) a contact representative associated with the supplier; (ix) information security provided by the supplier; (x) a continuity assessment associated with the supplier; and/or (xi) performance metrics associated with the supplier. An organization may collect and/or store supplier data 25 by conducting surveys of suppliers, reviewing public records, aggregating previously stored data (such as, e.g. name, address, or region of a supplier), and/or in any other appropriate manner.

In step 402, data sources 20 transmit supplier data 25 to risk analysis server 30. Data sources 20 may transmit supplier data 25 to risk analysis server 30 periodically and/or in response to a request from risk analysis server 30.

In step 404, risk analysis server 30 receives supplier data 25 from one or more data sources 20. In some embodiments, a particular supplier data 25 may be in different format and/or condition relative to other supplier data 25 associated with the same supplier. For example, some supplier data 25 may include data fields that other supplier data 25 does not include, or contains fields in a different order, or includes fields of a different data type. Risk analysis server 30 may reformat, condition, and/or otherwise analyze supplier data 25 in any appropriate manner to collate supplier data 25 received from disparate data sources 20. For example, risk analysis server 30 may determine that a supplier identification number in a first supplier data 25 received from data source 20a is the same as a supplier identification number in a second supplier data 25 received from data source 20b. Risk analysis server 30 may then determine that the first supplier data 25 and the second supplier data 25 are associated with the same supplier, and should analyze supplier risk associated with the supplier utilizing all or part of both the first supplier data 25 and the second supplier data 25.

In step 406, risk analysis server 30 calculates one or more risk assessment metrics based on supplier data 25. As discussed above with respect to FIG. 1, risk analysis server 30 may calculate a deliverable quality index, a performance scorecard, and/or a supplier risk index.

In step 408, once one or more supplier risk assessment metrics are calculated, risk analysis server 30 may calculate a supplier portfolio index. A supplier portfolio index may be an average of a deliverable quality index, a performance scorecard, and a supplier risk index. In certain embodiments, this may be represented as a percentage (such as, e.g. 86% secure). A supplier portfolio index may provide a holistic view of the risk associated with one or more, or all of the suppliers to an organization.

In step 410, users 40 at workstations 45 may connect to risk analysis server 30 to view risk information associated with one or more suppliers. In particular embodiments, a GUI displays one or more suppliers of an organization. Suppliers may be selectable based on user-defined criteria. Thus, users 40 may be able to view suppliers that meet certain user-defined criteria, and the risk assessment metric associated with the selected suppliers.

The steps illustrated in FIG. 4 may be combined, modified, or deleted where appropriate, and additional steps may also be added to those shown. Additionally, the steps may be performed in any suitable order without departing from the scope of the present disclosure.

FIG. 5 is a flow diagram illustrating an operation in accordance with a particular embodiment of supplier risk analysis system 10. In the illustrated example, operation begins at step 500 with data sources 20a-d collecting and/or storing supplier data 25. As discussed above, supplier data 25 may represent (i) an amount the organization spends with the supplier each year; (ii) a contract term associated with the supplier; (iii) a statement of work associated with the supplier; (iv) a criticality of the service provided by the supplier; (v) financial terms associated with the supplier (e.g., whether a contract is written on organization paper or supplier paper); (vi) one or more products provided by the supplier; (vii) contract provisions associated with the supplier; (viii) a contact person associated with the supplier; (ix) information security provided by the supplier; (x) a continuity assessment associated with the supplier; and/or (xi) performance metrics associated with the supplier. An organization may collect and/or store supplier data 25 by conducting surveys of suppliers, reviewing public records, aggregating previously stored data (such as, e.g. name, address, or region of a supplier), and/or in any other appropriate manner.

In step 502, risk analysis server 30 calculates information security risk score 52 based on an inherent information security risk value and additional supplier data 25. An inherent information security risk value may be determined based on survey data completed by a supplier and transmitted as supplier data 25 to risk analysis server 30. An inherent information security risk value may represent a degree of security a supplier has over customer, financial, or other sensitive data. Additional information, such as, for example, whether a supplier is working with an organization to improve its information security, whether there has been a privacy breach with information within a predetermined time period, whether a supplier uses antiquated computer systems, whether a supplier has undergone a security audit, the results of any information security audits, compliance with third-party security guidelines may each be assigned a value and combined with an inherent information security risk value.

In step 504, risk analysis server 30 calculates business continuity risk score 54 based in part on an inherent business continuity risk value. An inherent business continuity risk value may be based on supplier data 25 received from data sources 20. An inherent business continuity risk value represents likelihood a supplier will continue operations in the future, thus being available to provide continued goods or services to an organization. An inherent business continuity risk value may be determined based on survey data completed by a supplier and transmitted as supplier data 25 to risk analysis server 30. Additional information, such as, for example, whether a supplier is working with an organization to remedy deficiencies in business continuity, whether the supplier is operating in a country with a high degree of crime, terrorism, and/or political risk, whether an application is hosted by the supplier or the organization, and/or whether a test exercise of business continuity has been conducted may each be assigned a value and combined with an inherent business continuity value to calculate business continuity risk score 54, in a manner similar to calculating information security risk score 52.

In step 508, risk analysis server 30 calculates operational risk score 56 based on an inherent operational risk value and additional supplier data 25. An inherent operational risk value may be based on supplier data 25, and represents the risk to operations of an organization if supplier is no longer available, including reputational risk. An inherent operational risk value may be determined based at least in part on supplier data 25. Additional information, such as, for example, whether a supplier is meeting service level agreements, whether application recovery times are satisfactory, whether audits of change management have been performed, and/or the results of audits of change management may each be assigned a value and combined with an inherent operational risk value to calculate operational risk score 56, in a manner similar to calculating information security risk score 52.

In step 510, risk analysis server 30 calculates supply chain risk score 58 based on an inherent supply chain risk value and additional supplier data 25. An inherent supply chain risk value may be based on supplier data 25, and represents the risk to the supply chain of suppliers. Additional information, such as, for example, whether a supplier has an evergreen contract, has received demand letters within a predetermined time period, whether a contract covers deliverable quality requirements, whether the supplier is compliant with deliverable quality requirements, whether deliverable quality waivers exist may each be assigned a value and combined with an inherent business continuity value to calculate supply chain risk score 58, in a manner similar to calculating information security risk score 52.

In step 512, risk analysis server 30 calculates financial risk score 60 based on an financial risk value and additional supplier data 25. An inherent financial risk value may be based on supplier data 25, and represents the financial risk to an organization by a supplier. Additional information, such as, for example, whether revenue from a supplier is dependable, whether a line of business contingency plan is completed, whether a line of business contingency plan meets service level agreements, and/or whether the latest source code from an application vendor is in escrow may each be assigned a value and combined with an inherent business continuity value to calculate financial risk score 60, in a manner similar to calculating information security risk score 52.

In step 514, risk analysis server 30 calculates supplier health score 62. Supplier health score 62 may be based on a weighted average of information security risk score 52, business continuity risk score 54, operational risk score 56, supply chain risk score 58, and/or financial risk score 60. For example, information security risk score 52 may be calculated to be 7.5, business continuity risk score 54 may be calculated to be 58, operational risk score 56 may be calculated to be 53, supply chain risk score 58 may be calculated to be 56, and financial risk score 51 may be calculated to be 51. Predetermined weights may be applied to each respective value. As an example, information security risk score 52 may be 30%, business continuity risk score 54 may be 30%, operational risk score 56 may be 16%, supply chain risk score 58 may be 12%, and financial risk score 60 may be 12%. However, in general, any appropriate percentages may be applied depending on the particular configuration of supplier risk analysis system 10. Risk analysis server 30 applies those percentage to their respective scores to determine supplier health score 62, which, for purposes of this example, has a value of 44.

In step 516, risk analysis server 30 determines whether a supplier has a customer relationship and/or a strategic partnership relationship to the organization. If so, operation proceeds at step 518. If not, operation proceeds at step 520.

In step 518, risk analysis server 30 determines overall supplier relationship health score 64. In some embodiments, risk analysis server 30 adds a percentage to supplier health score 62 if a supplier has a customer relationship with an organization and/or has a strategic partnership relationship to the organization to determine overall supplier relationship health score 64. For example, risk analysis server 30 determines that a supplier has a customer relationship with the organization, and adds 10% to supplier health score 62.

In step 520, user 40 requests a supplier health score 62 and/or overall supplier relationship health score 64 for a particular supplier. Risk analysis server 30 may transmit supplier health score 62, overall supplier relationship health score 64 and/or any other appropriate information to user 40 as part of GUI 300.

The steps illustrated in FIG. 5 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method for determining a supplier operational risk rating comprising:
receiving a first supplier data from a first data source, the first supplier data indicating a plurality of suppliers and one or more risk characteristics associated with each of the plurality of suppliers to an organization;
receiving a second supplier data from a second data source, the second supplier data indicating a plurality of suppliers and one or more risk characteristics associated with each of the plurality of suppliers to the organization;
for one or more of the suppliers indicated in the first supplier data, associating one or more risk characteristics indicated in the first supplier data with one or more risk characteristics indicated in the second supplier data;
selecting, based on user input, a supplier from the plurality of suppliers;
based on the associated risk characteristics, calculating a supplier health score associated with the selected supplier.

2. The method of claim 1, further comprising determining whether the selected supplier is a customer of the organization and/or a strategic partner of the organization; and
based on the determination, calculating an overall supplier relationship health score.

3. The method of claim 2, wherein calculating an overall supplier relationship health score comprising adding a predetermined percentage to the supplier health score if the selected supplier is a customer and/or strategic partner of the organization.

4. The method of claim 1, wherein calculating a supplier health score comprises calculating a supplier health score based in part on an information security risk score, a business continuity risk score, an operational risk score, a supply chain risk score, and a financial risk score.

5. The method of claim 4, wherein calculating a supplier health score comprises:
applying a predetermined percentage to each of the information security risk score, the business continuity risk score, the operational risk score, the supply chain risk score, and the financial risk score; and
combining the information security risk score, the business continuity risk score, the operational risk score, the supply chain risk score, and the financial risk score after a predetermined percentage is applied.

6. The method of claim 1, further comprising transmitting the supplier health score to a user by causing to display the supplier health score on a display associated with the user.

7. A system for determining a supplier health comprising:
a memory operable to store a first supplier data and a second supplier data; and
a processor operable to:
receive a first supplier data from a first data source, the first supplier data indicating a plurality of suppliers and one or more risk characteristics associated with each of the plurality of suppliers to an organization;
receive a second supplier data from a second data source, the second supplier data indicating a plurality of suppliers and one or more risk characteristics associated with each of the plurality of suppliers to the organization;
for one or more of the suppliers indicated in the first supplier data, associate one or more risk characteristics indicated in the first supplier data with one or more risk characteristics indicated in the second supplier data;
select, based on user input, a supplier from the plurality of suppliers;
based on the associated risk characteristics, calculate a supplier health score associated with the selected supplier.

8. The system of claim 7, wherein the processor is further operable to determine whether the selected supplier is a customer of the organization and/or a strategic partner of the organization; and
based on the determination, calculate an overall supplier relationship health score.

9. The system of claim 8, wherein the processor is operable to calculate an overall supplier relationship health score comprising adding a predetermined percentage to the supplier health score if the selected supplier is a customer and/or strategic partner of the organization.

10. The method of claim 7, wherein the processor is operable to calculate a supplier health score by calculating a supplier health score based in part on an information security risk score, a business continuity risk score, an operational risk score, a supply chain risk score, and a financial risk score.

11. The method of claim 10, wherein the processor is operable to calculate a supplier health score by:
applying a predetermined percentage to each of the information security risk score, the business continuity risk score, the operational risk score, the supply chain risk score, and the financial risk score; and
combining the information security risk score, the business continuity risk score, the operational risk score, the supply chain risk score, and the financial risk score after a predetermined percentage is applied.

12. The system of claim 7, wherein the processor is further operable to transmit the supplier health score to a user by causing to display the supplier health score on a display associated with the user.

13. A non-transitory computer-readable medium comprising logic, the logic operable, when executed on a processor, to:
receive a first supplier data from a first data source, the first supplier data indicating a plurality of suppliers and one or more risk characteristics associated with each of the plurality of suppliers to an organization;
receive a second supplier data from a second data source, the second supplier data indicating a plurality of suppliers and one or more risk characteristics associated with each of the plurality of suppliers to the organization;
for one or more of the suppliers indicated in the first supplier data, associate one or more risk characteristics indicated in the first supplier data with one or more risk characteristics indicated in the second supplier data;
select, based on user input, a supplier from the plurality of suppliers;
based on the associated risk characteristics, calculate a supplier health score associated with the selected supplier.

14. The non-transitory computer-readable medium of claim 13, wherein the logic is further operable to determine whether the selected supplier is a customer of the organization and/or a strategic partner of the organization; and
based on the determination, calculate an overall supplier relationship health score.

15. The non-transitory computer-readable medium of claim 14, wherein the logic is operable to calculate an overall supplier relationship health score comprising adding a predetermined percentage to the supplier health score if the selected supplier is a customer and/or strategic partner of the organization.

16. The non-transitory computer-readable medium of claim 13, wherein the logic is operable to calculate a supplier health score by calculating a supplier health score based in part on an information security risk score, a business continuity risk score, an operational risk score, a supply chain risk score, and a financial risk score.

17. The non-transitory computer-readable medium of claim 16, wherein the logic is operable to calculate a supplier health score by:
applying a predetermined percentage to each of the information security risk score, the business continuity risk score, the operational risk score, the supply chain risk score, and the financial risk score; and
combining the information security risk score, the business continuity risk score, the operational risk score, the supply chain risk score, and the financial risk score after a predetermined percentage is applied.

18. The non-transitory computer-readable medium of claim 13, wherein the logic is further operable to transmit the supplier health score to a user by causing to display the supplier health score on a display associated with the user.
